(19) United States
(12) Patent Application Publication
(10) Pub. No.: US 2017/0097877 A1
(43) Pub. Date: Apr. 6, 2017

(54) VARIED STORAGE MEDIA DENSITY FOR DATA STORAGE DEVICES IN VIBRATIONAL ENVIRONMENTS

(71) Applicant: HGST Netherlands B.V., Amsterdam (NL)

(72) Inventors: Abhishek Dhanda, San Jose, CA (US); Toshiki Hirano, San Jose, CA (US); Satoshi Yamamoto, San Jose, CA (US)

(21) Appl. No.: 14/875,545

(22) Filed: Oct. 5, 2015

(51) Int. Cl. G06F 11/30; G06F 3/06

(52) U.S. Cl. CPC G06F 11/3058; G06F 3/0689; G06F 3/0619; G06F 3/0665; G06F 3/0653

(57) ABSTRACT

To provide enhanced operation of data storage devices and systems, various systems, apparatuses, methods, and software are provided herein. In a first example, a data storage system is presented. The data storage system includes data storage devices each configured for storage of data at associated storage media densities. The data storage system includes a control processor configured to vary storage media densities of ones of the plurality of data storage devices based at least on positioning of the plurality of data storage devices within an associated enclosure.

### TECHNICAL FIELD

Aspects of the disclosure are related to the field of data storage and data storage device devices in data storage systems.

### TECHNICAL BACKGROUND

Computer and network systems such as data storage systems, server systems, cloud storage systems, personal computers, and workstations, typically include data storage devices for storing and retrieving data. These data storage devices can include hard disk drives (HDDs), solid state storage drives (SSDs), tape storage devices, optical storage drives, hybrid storage devices that include both rotating and solid state data storage elements, and other mass storage devices.

As computer systems and networks grow in numbers and capability, there is a need for ever increasing storage capacity. Data centers, cloud computing facilities, and other at-scale data processing systems have further increased the need for digital data storage systems capable of transferring and holding immense amounts of data. Data centers can house this large quantity of data storage devices in various rack-mounted and high-density storage configurations.

While densities and workloads for the data storage devices increase, individual data enclosures can experience increased failure rates due to the increased densities and higher operating temperatures. Moreover, tight packing of data storage devices within enclosures, such as within rack-mount modular units, can lead to harsher vibrational environments for data storage devices. These harsh vibrational environments can affect reliability and readability of data storage devices, such as in rotating magnetic media storage devices.

### Overview

To provide enhanced operation of data storage devices and systems, various systems, apparatuses, methods, and software are provided herein. In a first example, a data storage system is presented. The data storage system includes data storage devices each configured for storage of data at associated storage media densities. The data storage system includes a control processor configured to vary storage media densities of ones of the plurality of data storage devices based at least on positioning of the plurality of data storage devices within an associated enclosure.

In another example, a method of operating a data storage system is provided. The method includes storing data at associated storage media densities on data storage devices. The method includes varying the storage media densities of ones of the plurality of data storage devices based at least on positioning of the plurality of data storage devices within an associated enclosure.

In another example, a data storage device is provided. The data storage device includes a rotating storage media configured to store data, a vibration sensor configured to monitor vibration characteristics experienced by the data storage device, and a control processor configured to establish a track spacing for storing the data on the rotating storage media based at least on the vibration characteristics.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a data system.

FIG. 2 is a flow diagram illustrating a method of operation of a data storage system.

FIG. 3 is a system diagram illustrating a data system.

FIG. 4 is a flow diagram illustrating a method of operation of a data storage system.

FIG. 5 is a diagram illustrating vibration characteristics.

FIG. 6 is a block diagram illustrating a control system.

### DETAILED DESCRIPTION

Data storage devices, such as hard disk drives (HDDs), solid state drives (SSDs), and hybrid disk drives that have both rotating and solid state storage elements, can be included in various arrayed configurations, such as rack-mounted modular enclosures which house dozens of individual drives. Cooling or ventilation fans can be included with the enclosures to direct airflow over the various drives. Power supply equipment can also be included to provide power to the various storage devices, to convert input power from a utility or building infrastructure to a form usable by the storage devices.

Drives which incorporate rotating media, such as rotating magnetic media of hard disk drives or hybrid disk drives, among others, also include various electromechanical elements to position read/write heads over the spinning media. These electromechanical elements include armatures, motors, actuators, voicecoils, servos, or other elements which can be affected by vibration of the drive elements themselves or by vibrational environment in which the drives are included. For example, a drive which performs many random read/write operations can induce more vibration into the surrounding environment of that drive due to rapid movements of the associated electromechanical elements within the drive. Other components within a storage enclosure, such as fans, can also affect the vibration levels within an associated enclosure.

The examples herein discuss various systems, software, devices, and methods to compensate for the vibrational disturbance environment of a storage enclosure. Specifically, data densities of storage media used to store data can be varied based on vibration levels experienced by the associated storage devices. In many examples, a position within an enclosure can affect the vibration level experienced by a storage drive, such as when a storage drive is proximate to a fan or another storage drive. In rotating magnetic media examples, a track spacing can be varied, such as measured by a track-per-inch (TPI) metric, to compensate for the vibrational environment.

Additionally, the vibrations can affect track misregistration (TMR) or write-to-write track misregistration (WW-TMR) in rotating magnetic media examples. TMR is a measure of how accurate track-to-track movements occur for read/write head elements among the various concentric tracks of a rotating storage media. Higher vibration levels can increase TMR and WW-TMR, which can affect data integrity during writing of associated data onto the storage media. Advantageously, in the examples herein, TMR and WW-TMR, among other effects of vibration, can be alleviated by altering storage density in data storage devices which experience higher levels of vibration due to proximity of noisy elements like fans. Likewise, storage density can be increased for devices which experience less vibration. In the aggregate, a higher capacity data storage system can be achieved by selectively decreasing storage densities of some of the various data storage devices but offsetting the decreased storage densities by increasing storage densities for other ones of the data storage devices.

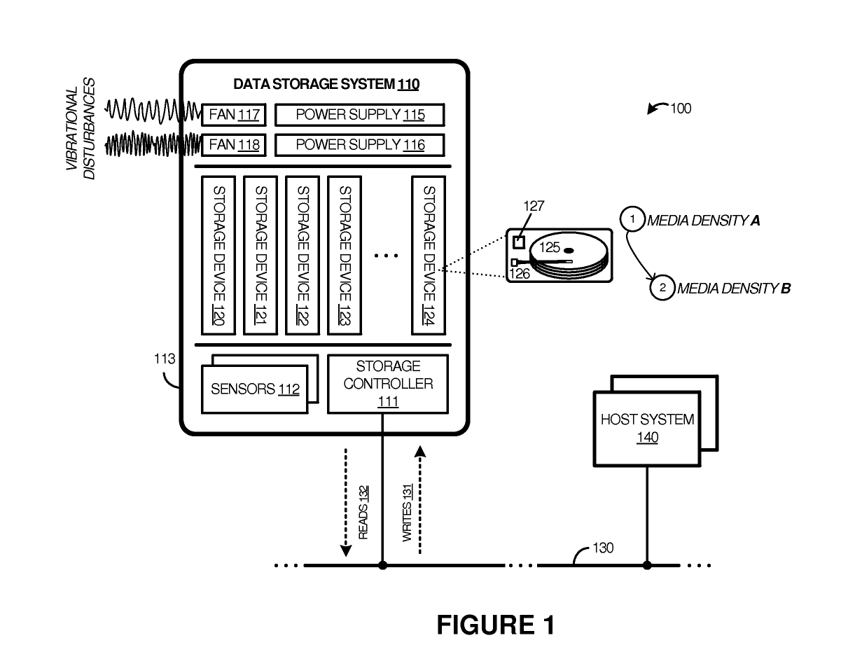

As a first example of a data storage system, FIG. 1 is presented. FIG. 1 is a system diagram illustrating system 100. System 100 includes data storage system 110 and one or more host systems 140. Data storage system 110 and host system 140 communicate over storage link 130. Data storage system 110 can be included in an environment that includes one or more data storage arrays, such as a rackmount computing environment.

In FIG. 1, data storage system 110 comprises an assembly that includes storage controller 111, sensors 112, enclosure 113, a plurality of power supplies 115-116, a plurality of fans 117-118, and a plurality of data storage devices 120-124. Each of data storage devices 120-124 can include one or more rotating storage media, such as shown in the detailed view for data storage device 124 as including rotating media 125, read/write heads/armature assembly 126, and vibration sensor 127. In some examples, ones of data storage devices 120-124 include solid state storage media, and may omit rotating media, or can include combinations of rotating and solid state storage media.

Storage controller 111 is communicatively coupled to data storage devices 120-124 and sensors 112. Although storage controller 111 is shown as internal to data storage system 110 in this example, it should be understood that in other examples storage controller 111 can be included in other elements external to data storage system 110. Furthermore, elements of storage controller 111 can be included in individual ones of data storage devices 120-124.

In operation, data storage system 110 receives read or write transactions over storage link 130 issued by host system 140, such as write operations 131 and read operations 132. Responsive to read operations, individual data storage devices in data storage system 110 can retrieve data stored upon associated storage media for transfer to host system 140. Responsive to write operations, individual data storage devices in data storage system 110 store data on the associated storage media. It should be understood that other components of data storage system 110 and data storage devices 120-124 are omitted for clarity in FIG. 1, such as transaction queues, chassis, interconnect, read/write heads, media, armatures, preamps, transceivers, processors, amplifiers, motors, servos, enclosures, and other electrical and mechanical elements.

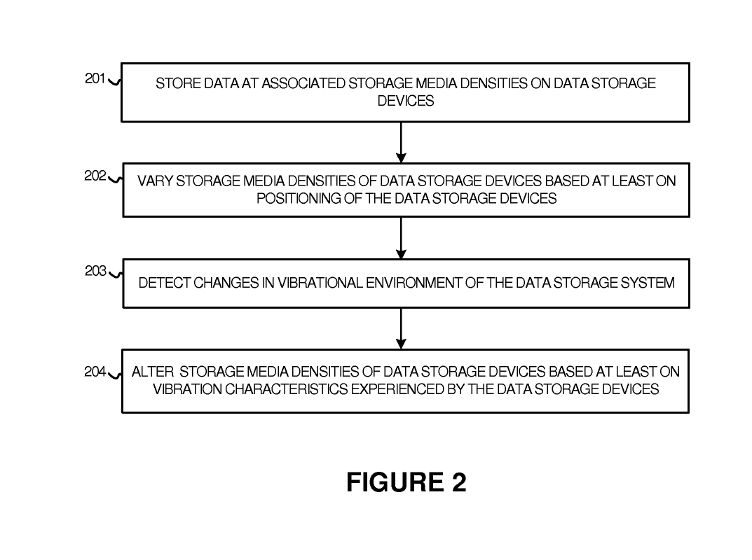

To further illustrate the operation of data system 100, FIG. 2 is provided. FIG. 2 is a flow diagram illustrating a method of operating data storage system 110. The operations of FIG. 2 are referenced below parenthetically. In FIG. 2, data storage system 110 stores and retrieves data in data storage system 110 using data storage devices 120-124 positioned in enclosure 113. Data storage system 110 receives read and write operations over host interface 130 and ones of data storage device 120-124 can handle these operations, such as by storing write data or retrieving read data. Read operations can include reads 132 received by storage controller 111, and write operations can include writes 131 received by storage controller 111. Other transactions or operations can be received for handling by storage controller 111, such as metadata operations, maintenance operations, or administration operations, among others.

Each of data storage devices 120-124 stores (201) data at associated storage media densities. The storage media densities can comprise a quantity of storage blocks per unit of storage area on a storage medium, such as tracks-per-inch (TPI) metrics on a rotating magnetic storage media. Other storage densities can be designated, such as bits per square inch, bits per inch, blocks per unit area, track-to-track spacing, or other storage media density. In TPI examples, a track spacing can indicate how closely adjacent tracks are packed when writing data in concentric tracks on an associated rotating media.

Typically, the tracks spacing, or TPI metric, is not varied once initially set by a storage device. However, in these examples, storage controller 111 varies (202) storage media densities of data storage devices 120-124 based at least on positioning of the data storage devices 120-124. The positioning comprises a position or location within an associated enclosure, such as a slot or tray within enclosure 113, or can also comprise a position or location with respect to other components of data storage system 110, such as fans or noisy elements.

Data storage system 110 includes many data storage drives along with associated power supplies and fans, among other equipment and cabling. Data storage devices 120-124 can be positioned at various locations within enclosure 113, such as in predefined spaces or slots to form an arrayed storage system. The positioning of data storage devices 120-124 within enclosure 113 can be identified when data storage devices 120-124 are installed in enclosure 113. Variation of storage densities among data storage devices 120-124 can be established after installation of data storage devices 120-124 within enclosure 113, and can consider factors such as physical position, chassis attachment characteristics, proximity to other devices, fans, power supplies, and the like, or other factors. The position can be identified by an operator of data storage system 110, such as by a user entering a physical position of data storage devices 120-124 within enclosure 113. Alternatively, the positioning can be identified by data storage devices 120-124 themselves, such as by connector or selector pins, jumpers, automatic position detection, or other positioning detection techniques.

Discrete storage media density levels can be established for data storage devices 120-124, which can be selected among based on positioning within enclosure 113, such as low, medium, and high storage media density levels which can correspond to vibration or disturbance levels associated with positioning within enclosure 113. For example, data storage device 120 might be positioned proximate to a fan or fans within enclosure 113, such as fan 118. Fans can produce vibrations and other disturbances which can affect the vibrational environment in which data storage device 120 operates. Data storage device 120 can then have a storage media density for an associated storage media changed to a lower density which can more effectively handle the higher vibrational environment nearby fan 118. Conversely, data storage device 124 might be positioned further from a fan than data storage device 120 and can thus experience a lesser vibrational environment. Data storage device 124 can have a storage media density for an associated storage media changed to a higher density than data storage device 120.

Storage controller 111 detects (203) changes in vibrational environment of the data storage system. Although position of a data storage device can be considered when establishing storage media densities for the data storage device, this position might not change once the data storage device is installed in enclosure 113. During operation of data storage system 110, further monitoring can be performed to determine vibration characteristics experienced by each data storage device. These vibration characteristics can be affected by operational changes in data storage system 110, such as workload of the data storage devices, fan operation, failure of one or more fans, failure of one or more data storage devices, and the like. Additionally, neighboring data storage devices might be designated to handle more random read/write traffic and thus create more vibrational disturbances to nearby data storage drives which handle more sequential or burst writing. Random read/writes can create more vibrational disturbances due to rapid re-positioning of read/write head elements by associated armatures. Fan vibration can change over time, such as due to dust build-up, warpage of fins/blades, fan speed changes, bearing wear, brush wear, or fan failures.

Responsive to these operational changes in vibration disturbance, storage controller 111 alters (204) storage media densities of data storage devices based at least on vibration characteristics experienced by the data storage devices. The storage media densities can be increased for ones of data storage devices 120-124 which experience lesser vibrational disturbance levels over a period of time and can be decreased for ones of data storage devices 120-124 which experience greater vibrational disturbance levels over the period of time.

Various upper and lower thresholds, windows, or levels can be established for the vibrational disturbance levels which trigger changes in storage media densities for individual ones of the data storage devices. Additionally, the vibration characteristics can be measured or characterized in energy, power, or other metrics and calculated into peak levels, root-mean-square (RMS) levels, means, averages, max/min, or other levels, including combinations thereof. Actual vibration disturbance levels can be measured using accelerometers embedded in various locations of data storage system 110, such as in each of data storage devices 120-124.

Although storage controller 111 is discussed above as monitoring vibration characteristics and altering or varying storage densities of data storage devices, it should be understood that these operations can be performed by other elements of data storage system 110. For example, each of data storage devices 120-124 can monitor associated vibration levels to identify associated vibration characteristics, such as by employing vibration sensors 127. Data storage devices 120-124 can report these vibration characteristics to storage controller 111 and storage controller can responsively alter storage media densities. In other examples, data storage devices 120-124 can alter their own storage media densities responsive to changes in vibration characteristics, or to a detected position in enclosure 113.

Returning to the elements of FIG. 1, data storage system 110 comprises a plurality of data storage devices 120-124. These data storage devices are coupled to storage controller 111 by one or more storage links, which can comprise a serial ATA interface, Serial Attached Small Computer System (SAS) interface, Integrated Drive Electronics (IDE) interface, Non-Volatile Memory Express (NVMe) interface, ATA interface, Peripheral Component Interconnect Express (PCIe) interface, Universal Serial Bus (USB) interface, wireless interface, Direct Media Interface (DMI), Ethernet interface, networking interface, or other communication and data interface, including combinations, variations, and improvements thereof. Data storage system 110 can also comprise cache systems, chassis, enclosures, fans, interconnect, cabling, or other circuitry and equipment.

Storage controller 111 includes processing circuitry, communication interfaces, and one or more non-transitory computer-readable storage devices. The processing circuitry can comprise one or more microprocessors and other circuitry that retrieves and executes firmware from memory for operating as discussed herein. The processing circuitry can be implemented within a single processing device but can also be distributed across multiple processing devices or sub-systems that cooperate in executing program instructions. Examples of the processing circuitry include general purpose central processing units, application specific processors, and logic devices, as well as any other type of processing device, combinations, or variations thereof. The communication interfaces can include one or more storage interfaces for communicating with host systems, networks, and the like. The communication systems can include transceivers, interface circuitry, connectors, buffers, microcontrollers, and other interface equipment.

Sensors 112 can include analog or digital vibration sensors configured to detect vibration in enclosure 113, near any of data storage devices 120-124, or vibration associated with other elements of data storage system 110, such as fans 117-118. Vibration sensors can include accelerometers, gyroscopic sensors, acoustic sensors, or other vibration sensors. In further examples, sensors 112 can include one or more sensors to detect opening of enclosure 113, such as for maintenance or replacement of various components. Sensors 112 can also detect failures of various components of data storage system 110, such as failure of power supplies, fans, data storage devices, and the like, which can affect the vibrational environment of data storage system 110. Sensors 112 can also include various interfaces for communicating measured information, such as to storage controller 111. These interfaces can include transceivers, analog-to-digital conversion elements, amplifiers, filters, signal processors, among other elements. In some examples, sensors 112 can each include microcontroller elements, programmable logic, or discrete logic to control the operations of sensors 112. In some examples, data storage devices 120-124 each can include ones of sensors 112, and data storage devices 120-124 can include equipment and circuitry to transfer sensor information over an associated storage or host interface to storage controller 111.

Enclosure 113 comprises structural elements to house and structurally support the elements of data storage system 110. Enclosure 113 can include chassis elements, frames, fastening elements, rackmount features, ventilation features, among other elements. In many examples, enclosure 113 also includes fans or other cooling and ventilation elements for providing airflow to the elements of data storage system 110.

Data storage system 110 also includes one or more power supplies 115-116 to convert external input power sources or provide various forms of electrical energy to the elements of data storage system 110. Power supplies 115-116 each comprise power conversion elements, power electronics, transformers, voltage conversion circuitry, among other elements. Power supplies 115-116 can also include one or more ventilation fans to provide cooling and ventilation to power supplies 115-116 and to other components in enclosure 113, such as indicated by fans 117-118, or additional fans.

Fans 117-118 provide airflow to elements within enclosure 113, such as the elements of data storage system 110. Fans 117-118 can comprise any fan type, such as axial-flow, centrifugal and cross-flow, or other fan types, including associated ducts, louvers, fins, or other directional elements, including combinations and variations thereof.

Each of data storage devices 120-124 includes one or more computer readable storage media accessible via one or more read/write heads and associated electromechanical elements. In FIG. 1, an example detailed view of data storage device 124 is shown to highlight rotating media 125 and read/write heads and armature assembly 126, and these elements can be included in each of data storage devices 120-124, although variations are possible among the data storage devices, such as when solid state media are employed. Data storage devices 120-124 can also each include processing circuitry, communication interfaces, armatures, preamps, transceivers, processors, amplifiers, motors, servos, enclosures, and other electrical and mechanical elements. Data storage devices 120-124 can each comprise a hard disk drive, hybrid disk drive, solid state drive, or other computer readable storage device, including combinations thereof. Data storage devices 120-124 can each include further elements, such as vibration sensors 127, which can comprise similar elements as sensors 112. The computer readable storage media of data storage devices 120-124 can each include rotating magnetic storage media, but can additionally include other media, such as solid state drive elements, caches, or cache systems. These other media can include solid state storage media, optical storage media, non-rotating magnetic media, phase change magnetic media, spin-based storage media, or other storage media, including combinations, variations, and improvements thereof. In some examples, data storage devices 120-124 each comprise a hybrid hard drive employing solid state storage elements in addition to rotating magnetic storage media. Associated storage media can employ various magnetic storage schemes, such as random write techniques, shingled magnetic recording (SMR), perpendicular magnetic recording (PMR), or heat-assisted magnetic recording (HAMR), including combinations, variations, and improvements thereof.

Host system 140 can include processing elements, data transfer elements, and user interface elements. In some examples host system 140 is a central processing unit of a computing device or computing system. In other examples, host system 140 also includes memory elements, data storage and transfer elements, controller elements, logic elements, firmware, execution elements, and other processing system components. In yet other examples, host system 140 comprises a RAID controller processor or storage system central processor, such as a microprocessor, microcontroller, Field Programmable Gate Array (FPGA), or other processing and logic device, including combinations thereof. Host system 140 can include, or interface with, user interface elements which can allow a user of data system 100 to control the operations of data system 100 or to monitor the status or operations of data system 100. These user interface elements can include graphical or text displays, indicator lights, network interfaces, web interfaces, software interfaces, user input devices, or other user interface elements. Host system 140 can also include interface circuitry and elements for handling communications over bus 130, such as logic, processing portions, buffers, transceivers, and the like.

Bus 130 can include one or more serial or parallel data links, such as a Peripheral Component Interconnect Express (PCIe) interface, serial ATA interface, Serial Attached Small Computer System (SAS) interface, Integrated Drive Electronics (IDE) interface, ATA interface, Universal Serial Bus (USB) interface, wireless interface, Direct Media Interface (DMI), Ethernet interface, networking interface, or other communication and data interface, including combinations, variations, and improvements thereof. Although one bus 130 is shown in FIG. 1, it should be understood that one or more discrete links can be employed between the elements of data system 100.

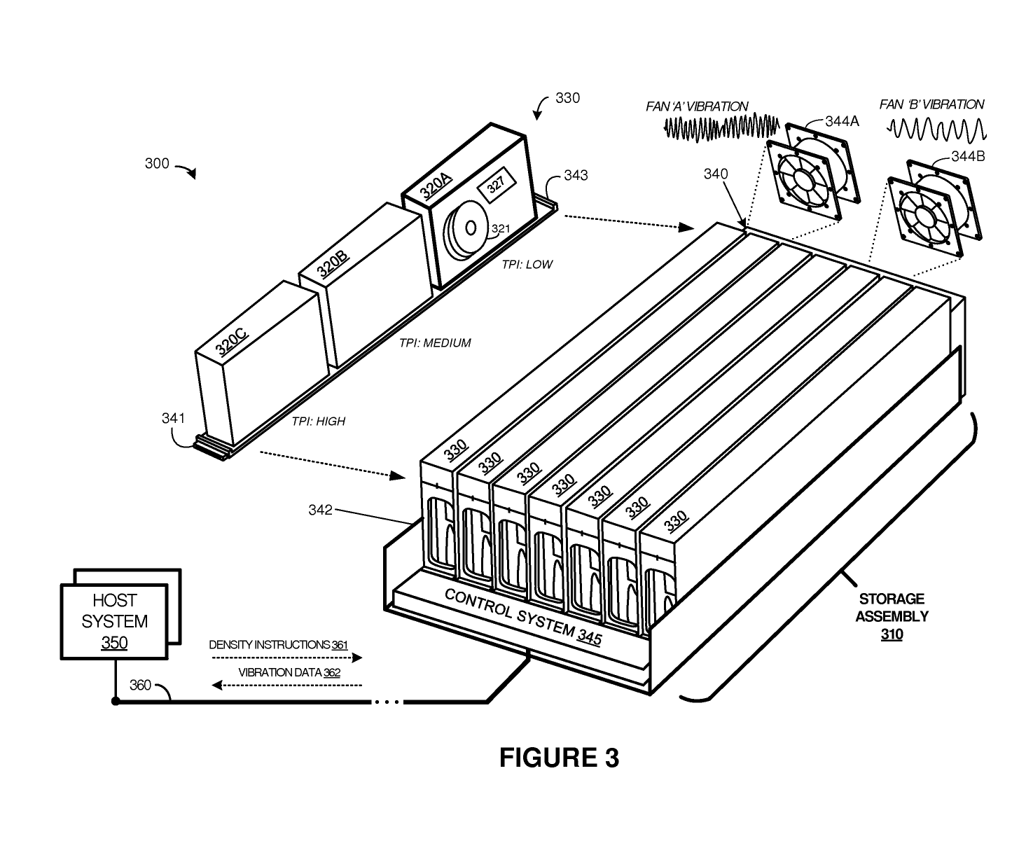

As a further example data storage system employing a data storage array, FIG. 3 is presented. FIG. 3 is a system diagram illustrating data storage system 300. Data storage system 300 includes storage assembly 310 and one or more host systems 350. Storage assembly 310 and host system 350 communicate over storage link 360. Various elements of storage assembly 310 can be included in data storage system 110 of FIG. 1, although variations are possible. Although one storage assembly 310 is shown in FIG. 3, it should be understood that more than one storage assembly could be included and linked to host system 350 or other host systems, such as in a data storage environment employing many data storage arrays.

Storage assembly 310 can comprise a storage assembly with associated enclosure and structural elements which is insertable into a rack that can hold other storage assemblies, such a rackmount server environment. The enclosure can include structural elements, such as chassis 342 and trays 343, to mount the plurality of storage drives and can also include at least one external connector for communicatively coupling storage devices to link 360.

Storage assembly 310 can comprise a redundant array of independent disks (RAID) array, or a JBOD device (“Just a Bunch Of Disks”) device which include a plurality of independent disks which can be spanned and presented as one or more logical drives to host system 350. In some examples, storage assembly 310 comprises a virtual bunch of disks (VBOD) which adds one or more layers of abstraction between physical storage drives and external interfaces. A VBOD can employ various types of magnetic recording technologies and abstract front-end interactions from the particular recording technology. For example, shingled magnetic recording (SMR) hard disk drives typically have inefficiencies for random writes due to the shingled nature of adjacent tracks for data. In SMR examples, the VBOD abstracts the SMR drives and allows random writes and random reads while still having underlying SMR media which ultimately hold the associated data. Other recording techniques can be employed, such parallel magnetic recording (PMR), or heat-assisted magnetic recording (HAMR), including variations, improvements, and combinations thereof.

Storage link 360 can include one or more links, although a single link is shown in FIG. 3. Storage link 360 can comprise a storage or disk interface, such as Serial Attached ATA (SATA), Serial Attached SCSI (SAS), FibreChannel, Universal Serial Bus (USB), SCSI, InfiniBand, NVMe, Peripheral Component Interconnect Express (PCIe), Ethernet, Internet Protocol (IP), or other parallel or serial storage or peripheral interfaces, including variations and combinations thereof.

Host system 350 can include one or more computing and network systems, such as personal computers, servers, cloud storage systems, packet networks, management systems, or other computer and network systems, including combinations and variations thereof. In operation, host system 350 issues read and write commands or operations to storage assembly 310 over storage link 360, among other commands or operations which can include control instructions, storage media density instructions, metadata retrieval operations, configuration instructions, and the like. Likewise, storage assembly 310 can transfer read data over storage link 360, among other information such as graphical user interface information, status information, operational information, vibration information, temperature information, power information, failure notifications, alerts, and the like.

Storage assembly 310 includes a plurality of hard disk drives (HDDs), each mounted in an associated carrier tray 343 which is further encased in an enclosure to form a storage carrier 330, such as shown for HDDs 320A-320C in tray 343 and storage carrier 330. A connector is provided for each of storage carriers 330 to couple the HDDs to an associated control system 345. Multiple storage carriers 330 can be included into storage assembly 310 to form a storage array. Each HDD can be inserted and removed into an associated storage carrier and that storage carrier can then be inserted into an associated guide or track of storage assembly 310. Other configurations are possible, such as individually-mounted HDDs. Each connector 341 couples to a mating connector in control system 345. In other examples, each connector 341 is individually coupled over a storage link to host system 350.

An exemplary detailed view of HDD 320A is shown in FIG. 3 to emphasize the rotating storage media 321 and vibration sensor 327. Each HDD can comprise similar elements, such as rotating storage media, read/write heads, and optionally vibration sensors, although variations are possible among HDDs. HDDs can include further elements, such as armatures, preamps, transceivers, processors, amplifiers, motors, servos, cases, seals, enclosures, and other electrical and mechanical elements. It should be understood that variations are possible for HDD 320A or other HDDs. Each HDD can instead comprise hybrid disk drives which include rotating media and solid state storage components which work in tandem. In further examples, solid state drives (SSDs), optical storage drives, or other non-transitory computer-readable storage devices are employed.

In FIG. 3, each HDD also optionally includes an associated vibration sensor 327, which can comprise an accelerometer, such as a solid-state multi-axis accelerometer or other vibration sensing elements, including associated interface circuitry. These vibration sensors can be included among the electronic or mechanical elements of each HDD, and can measure vibration characteristics associated with the HDD. Each HDD can also include equipment and circuitry to transfer positioning information, vibration characteristics, or other vibration information determined by the associated vibration sensors over an associated storage interface to the control system.

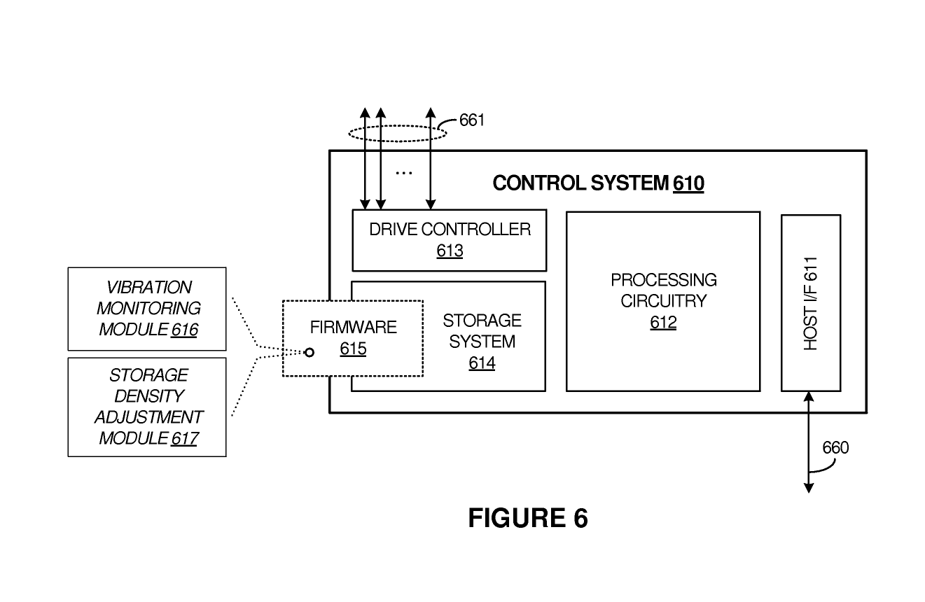

Control system 345 communicatively couples to each HDD and presents a unified host interface 360 to host system 350. Each HDD can be coupled to control system 345 by one or more storage links over connectors 341, such as Serial Attached SCSI (SAS) links, although other link types can be employed. FIG. 6 illustrates control system 610 which can be one example of control system 345 employed in storage assembly 310.

Storage assembly 310 includes power assembly 340 which comprises power electronics as well as one or more ventilation fans 340 to provide airflow to storage assembly 310. Storage assembly 310 also includes storage chassis 342 which comprises structural elements to house and structurally support the elements of storage assembly 310. Chassis 342 can include chassis elements, enclosures, cases, frames, fastening elements, rackmount features, ventilation features, among other elements. Power supply elements are included to convert external power sources or provide various forms of electrical power to the elements of storage assembly 310. Fans 344A-344B can comprise any fan type, such as axial-flow, centrifugal and cross-flow, or other fan types, including associated louvers, fins, or other directional elements, including combinations and variations thereof.

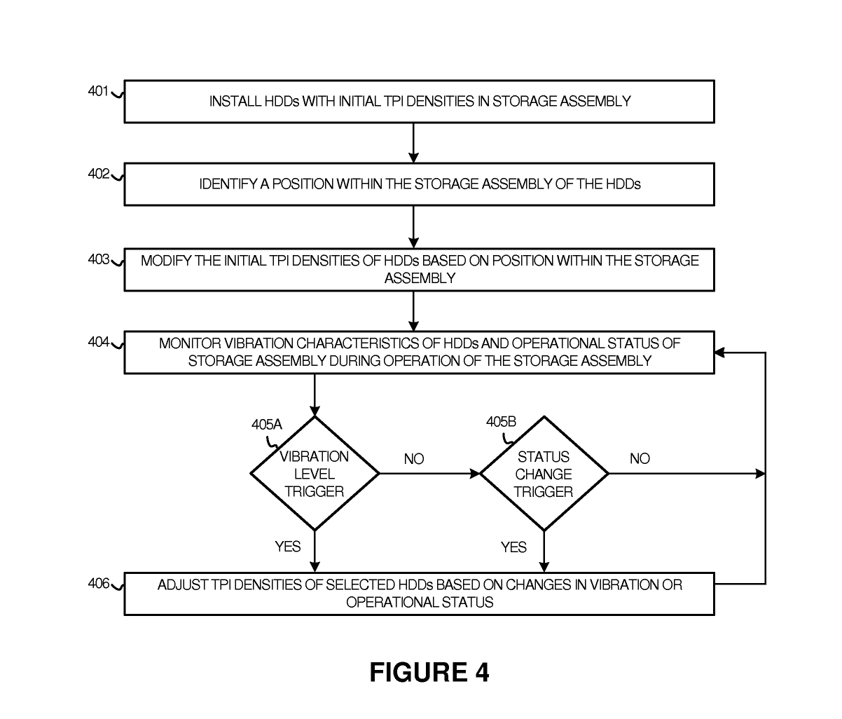

To further illustrate the operation of system 300 and storage assembly 310, FIG. 4 is presented. FIG. 4 is a flow diagram illustrating a method of operation of storage assembly 310. The operations of FIG. 4 are referenced below parenthetically. The various operations described herein for FIG. 4 can be performed by any combination of elements in storage assembly 310, such as control system 345, elements of HDDs 320, or instead by host system 350.

In FIG. 4, HDDs are installed (401) with initial track-per-inch (TPI) densities in storage assembly 310. Each of the HDDs installed in storage assembly 310, such as HDDs 320A-320C shown in FIG. 3, can have initial TPI densities associated therewith, such as set during manufacture, during a factory test process, or at another time. These initial TPI densities can be selected to be a similar value for all HDDs or on a per-model or per-type basis. These initial TPI densities might be set to conservative values to allow operation of the associated HDDs over a wide operational range, such as that specified by the manufacturer. The initial TPI densities might lead to storage capacities that are less than the maximum supportable by the HDDs, however, the initial TPI densities provision for various vibrational environments to compensate for variable environments into which the HDDs might be installed.

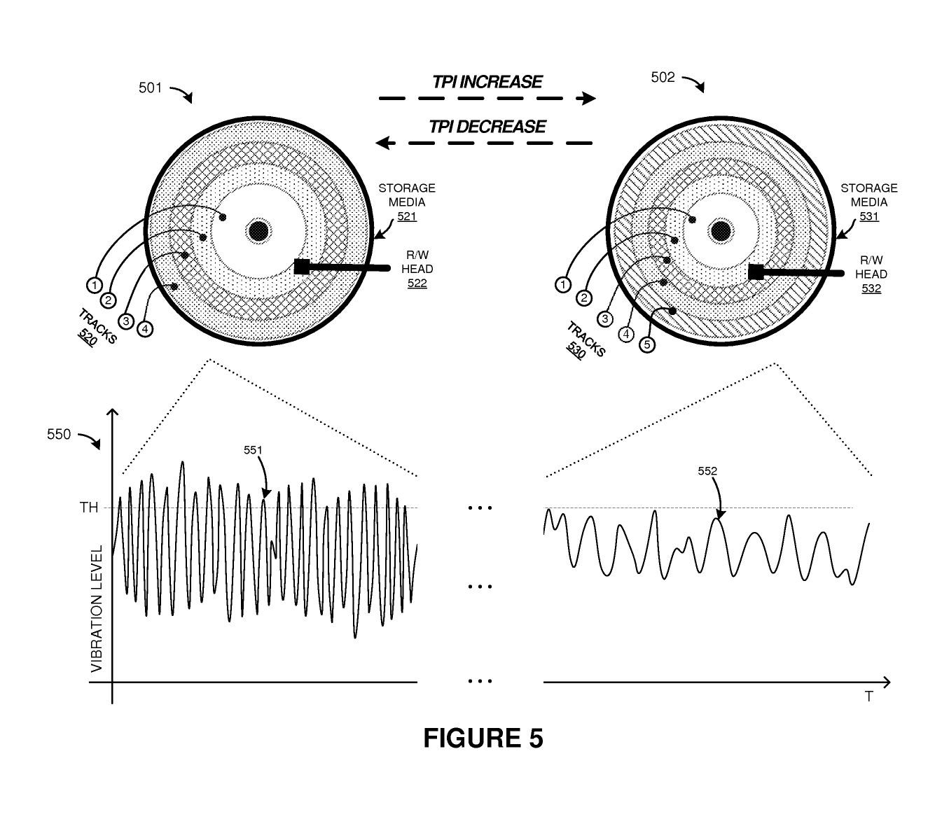

As a possible example of an initial TPI density, FIG. 5 illustrates density configuration 501. Configuration 501 shows four concentric tracks on rotating storage media 521. It should be understood that configuration 501 is merely exemplary, and in other examples more tracks are typically employed.

Control system 345 (402) identifies a position within storage assembly 310 of the HDDs. For example, in FIG. 3, a storage carrier might include three HDDs, and each HDD can have an associated position in the carrier as well as the carrier within storage assembly 310. Each HDD can have an associated position. The position can be identified as described herein, such as by use of jumpers or discrete signal lines to identify which HDD is in which position. Other examples include programmable positions or identities which indicate which position the HDD is located. A bus identity can be employed, such as where each HDD has an associated storage link and the storage links correspond to a specific location within storage assembly 310. Other examples include manual selection of a position for each HDD through a user interface of control system 345.

Once an absolute position is identified for each HDD, then relative positions can be identified. The relative positions can indicate which HDD is near fans or other vibration-inducing equipment, such as ones of the HDDs which handle higher workloads or higher levels of random read/write traffic.

Control system 345 (403) modifies the initial TPIs of HDDs based on position within storage assembly 310. As stated above, some HDDs might be positioned near fans 344A or 344B which can lead to higher vibration levels for those HDDs. Likewise, some HDDs might be positioned further away from fans 344A or 344B. Control system 345 modifies those HDDs nearby the fans to have a reduced TPI density to mitigate the higher vibrational disturbances caused by the fans. HDDs nearby the fans can be considered ones of the HDDs that are adjacent or proximate to the fans, such as the rearmost ones of the HDDs in FIG. 3. In some examples, the initial TPI levels might be sufficient to handle the vibration levels of the fans. Control system 345 modifies those HDDs further from the fans to have an increased TPI density as compared to the HDDs nearby the fans.

As a first example of varying TPI densities, FIG. 3 shows HDD 320A nearest to fan 344A and HDD 320B further from fan 344A, and HDD 320C as furthest from fan 344A. A low-medium-high TPI is show for associated ones of HDDs 320A-320C based on distance from fan 344A. Furthermore, FIG. 3 shows fan 344A as having a noisier operation than adjacent fan 344B. Thus, HDDs closer to fan 344B might not have as low TPI densities as compared to HDDs closer to fan 344A. To illustrate increased TPI density, configuration 502 of FIG. 5 is shown. Configuration 502 has 5 a higher TPI density, which allows for an additional track of data in FIG. 5. Actual TPI changes might vary from those shown in FIG. 5, and configuration 502 is merely exemplary.

To establish the increased or decreased TPI densities, control system 345 can transfer instructions or commands to each of the HDDs indicating new TPI densities that are to be employed. Data already written to the HDDs which received changed TPI density instructions might need to be re-written at the higher densities responsive to the instructions.

Control system 345 (404) monitors vibration characteristics of the HDDs and operational status of storage assembly 310 during operation of storage assembly 310. Vibration sensors, such as accelerometers, can be placed throughout storage assembly 310 to measure vibrational disturbance levels at various positions within storage assembly 310. In some examples, each of the HDDs includes a vibration sensor and thus vibration characteristics of each HDD can be monitored. The individual HDDs can monitor their own vibration levels and provide indications of the vibration levels to control system 345 as vibration characteristics. Control system 345 can collect the vibration characteristics from each HDD and from any additional vibration sensors.

The vibration levels can be indicated to control system 345 in various metrics, values, or units. For example, an average vibration energy level over time can be reported, such as over a rolling window of time. RMS, peak, max/min, or other levels can be indicated, as well as real-time vibration levels. Furthermore, indirect measurements of disturbance levels can be measured and reported to control system 345, such as track misregistration (TMR), write-to-write track misregistration (WW-TMR), media bit error rates, quantities of bits needing error correction during reads from the media, or other indirect measures of vibration.

In addition to vibration levels, control system 345 can monitor operational status of storage assembly 310. The operational status can include monitoring when a case or enclosure associated with storage assembly 310 is opened, such as when a component is replaced or maintained within storage assembly 310. The operational status can include trigger events comprising at least one of a fan malfunction event within the enclosure, an opening event of the enclosure, or a failure event of at least one of the HDDs. When the case or enclosure is opened, it can indicate a change in operational characteristics, such as replacement HDD, replacement fan, replacement power supply, or other changes, which can affect vibration levels of storage assembly 310. Operational failures of various components can also be monitored, such as when ones of fans 344A or 344B fail or experience degraded operation, when ones of the HDDs fail or experience degraded operation, among other operational characteristics of storage assembly 310.

The vibration levels and operational status are monitored during operation of storage assembly 310, such as during read and write operations. Storage assembly 310 receives read and write operations over storage link 360 that are transferred by host system 350. These read and write operations can be issued by host system 350, or other external systems. In write operations, write data is associated with one or more write operations which are received over link 360 from host system 350. Write data can comprise one or more data blocks for storage by storage assembly 310 which is directed for storage at a designated storage address or storage location among the HDDs of storage assembly 310. Storage assembly 310 stores the write data for later retrieval, such as read data for delivery to host system 350 over link 360. Read or write operations can be directed to any logical partition, and indicate a storage address, logical unit, partition, or other indication that designates logical blocks in storage assembly 310 to which read or write operations are directed.

FIG. 5 illustrates example vibration monitoring, such as by monitoring vibration levels experienced by a particular HDD in graph 550. Graph 550 can represent vibration levels measured by an accelerometer. In FIG. 5, vibration level curve 551 is shown to exceed an upper threshold level, TH. Other thresholds can be applied, such as threshold windows or lower threshold levels, among others. In this manner, threshold TH can indicate a vibration level trigger which can indicate that a TPI of that HDD might need modification. Operational triggers can also be indicative of a need to change TPIs for the various HDDs. FIG. 4 illustrates these in operations 405A and 405B.

When no triggers are met, then operation can continue without modification to the TPIs. However, when one or more of the triggers are met, then control system 345 can re-evaluate the current TPIs for the HDDs and modify or alter ones of the TPIs as desired. For example, when vibration levels for a particular HDD rise above a threshold level or fall below a threshold level, then the TPI for that HDD might be altered. Likewise, when a HDD, fan, or power supply is replaced or experiences a degraded condition, then TPIs for affected or proximate HDDs might be altered (406).

FIG. 5 shows an illustration of a change in vibration levels in graph 550. During a first period of time, a high level of vibration might be experienced, such as indicated by vibration level curve 551. Later, a second period of time might have a lower level of vibration, such as indicated by vibration level curve 552. Other vibration levels can be experienced. Control system 345 can alter TPIs of the various HDDs of storage assembly 310, whether increasing TPIs or decreasing TPIs, according to the vibration levels experienced by each of the HDDs or by the various operational status factors mentioned herein. TPI levels or densities can be altered to be higher density or lower density over time. For example, control system 345 might increase a TPI density for a first HDD if a lower vibration level is experienced by that HDD over time or after replacement of a noisy component, like an unbalanced or degraded fan. Control system 345 might decrease a TPI density for a particular HDD if a higher vibration level is experienced by that HDD over time or responsive to a component increasing in disturbance level, such as a degraded fan or noisy neighboring HDD.

Advantageously, TPIs of any of the HDDs in storage assembly 310 can be altered or otherwise modified to optimize the TPI for the particular vibrational environment experienced. HDDs that experience higher vibrational levels, such as for HDDs proximate to fans, can be configured to have lower TPI densities, whereas HDDs that experience lower vibrational levels, such as for HDDs not proximate to fans, can be configured to have higher TPI densities. These TPI densities can be altered from a factory or initial setting, and can lead to increased storage capacity in the aggregate for storage assembly 310. Specifically, a storage capacity of each HDD is affected by the associated TPI density employed. When storage capacities gained from the increases in TPI densities for individual HDDs exceed any storage capacity lost to any decreases in TPI densities, then an aggregate storage capacity is increased for storage assembly 310.

Once any changes to storage densities or TPI levels are made, the associated change in storage capacity is recalculated and reported. In examples where control system 345 handles storage operations of storage assembly 310, then control system 345 can report any changes in storage capacity for the HDDs to host system 350. In examples where host system 350 communicates with individual ones of the HDDs without intervening communications of control system 345, then the individual HDDs which experience changes in storage capacities report the changes to host system 350. The host reporting can occur over link 360 or other links, and can comprise one or more control messages or associated signaling.

Also, although the examples discussed in FIG. 4 relate to control system 345 monitoring vibration characteristics, operational status, and making any associated TPI changes for the individual HDDs in storage assembly 310, in other examples the individual HDDs can perform these operations. Specifically, each HDD in storage assembly 310 can monitor vibration characteristics using vibration sensors or other indirect measurements of vibration, and alter their own TPI densities or track spacing responsive to changes in vibration levels or operational status. Once any storage capacity is altered due to a TPI change, the individual HDDs can report the capacity changes to control system 345 or host system 350.

FIG. 6 is a block diagram illustrating control system 610. Control system 610 handles storage operations for a storage assembly. Control system 610 can be an example of storage controller 111 of FIG. 1, control system 345 of FIG. 3, controllers of HDDs 320 of FIG. 3, or included in elements of host system 350 of FIG. 3, although variations are possible. When control system 610 is included in a data storage assembly, control system 610 receives storage operations from host systems over storage link 660 by host interface 611. Write data can be received in one or more write operations, and read data can be provided to hosts responsive to one or more read operations.

Control system 610 includes host interface (I/F) 611, processing circuitry 612, drive controller 613, and storage system 614. Furthermore, control system 610 includes firmware 615 which includes vibration monitoring module 616 and storage density adjustment module 617 which, when executed by at least processing circuitry 612, operates as described below.

Host interface 611 includes one or more storage interfaces for communicating with host systems, networks, and the like over at least link 660. Host interface 611 can comprise transceivers, interface circuitry, connectors, buffers, microcontrollers, and other interface equipment. Host interface 611 can also include one or more I/O queues which receive storage operations over link 660 and buffers these storage operations for handling by processing circuitry 612. Link 660 can include one or more Ethernet interfaces, SATA interfaces, SAS interfaces, FibreChannel interfaces, USB interfaces, SCSI interfaces, InfiniBand interfaces, NVMe interfaces, or IP interfaces, which allows for the host system to access the storage capacity of HDD assembly.

Processing circuitry 612 can comprise one or more microprocessors and other circuitry that retrieves and executes firmware 615 from storage system 614. Processing circuitry 612 can be implemented within a single processing device but can also be distributed across multiple processing devices or sub-systems that cooperate in executing program instructions. Examples of processing circuitry 612 include general purpose central processing units, application specific processors, and logic devices, as well as any other type of processing device, combinations, or variations thereof. In some examples, processing circuitry 612 includes a system-on-a-chip device or microprocessor device, such as an Intel Atom processor, MIPS microprocessor, and the like.

Drive controller 613 can include one or more drive control circuits and processors which can control various data redundancy handling among the various data storage devices of a storage assembly. Drive controller 613 also includes storage interfaces 661, such as SAS interfaces to couple to the various data storage devices in a storage assembly. In some examples, drive controller 613 and processing circuitry 612 communicate over a peripheral component interconnect express (PCIe) interface or other communication interfaces. In some examples, drive controller 613 comprises a RAID controller, RAID processor, or other RAID circuitry. In other examples, drive controller 613 handles management of a particular recording technology, such as SMR or HAMR techniques. As mentioned herein, elements and functions of drive controller 613 can be integrated with processing circuitry 313.

Storage system 614 can comprise any non-transitory computer readable storage media readable by processing circuitry 612 or drive controller 613 and capable of storing firmware 615. Storage system 614 can include volatile and nonvolatile, removable and non-removable media implemented in any method or technology for storage of information, such as computer readable instructions, data structures, program modules, or other data. In addition to storage media, in some implementations storage system 614 can also include communication media over which firmware 615 can be communicated. Storage system 614 can be implemented as a single storage device but can also be implemented across multiple storage devices or sub-systems co-located or distributed relative to each other. Storage system 614 can comprise additional elements, such as a controller, capable of communicating with processing circuitry 612. Examples of storage media of storage system 614 include random access memory, read only memory, magnetic disks, optical disks, flash memory, SSDs, phase change memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media.

Firmware 615, vibration monitoring module 616, and storage density adjustment module 617 can be implemented in program instructions and among other functions can, when executed by control system 610 in general or processing circuitry 612 in particular, direct control system 610 or processing circuitry 612 to operate data storage systems as described herein. Firmware 615 can include additional processes, programs, or components, such as operating system software, database software, or application software. Firmware 615, vibration monitoring module 616, and storage density adjustment module 617 can also comprise software or some other form of machine-readable processing instructions executable by processing circuitry 612.

In at least one implementation, the program instructions can include first program instructions that direct control system 610 to handle read and write operations among the data storage devices, monitor vibration information or vibration characteristics for data storage devices or other components such as fans, power supplies, or other components (vibration monitoring module 616), take action to alter storage media densities for data storage devices associated with control system 610 responsive to vibration characteristics or positioning within a storage enclosure (storage density adjustment module 617), among other operations.

In general, firmware 615 can, when loaded into processing circuitry 612 and executed, transform processing circuitry 612 overall from a general-purpose computing system into a special-purpose computing system customized to operate as described herein. Encoding firmware 615 on storage system 614 can transform the physical structure of storage system 614. The specific transformation of the physical structure can depend on various factors in different implementations of this description. Examples of such factors can include, but are not limited to the technology used to implement the storage media of storage system 614 and whether the computer-storage media are characterized as primary or secondary storage. For example, if the computer-storage media are implemented as semiconductor-based memory, firmware 615 can transform the physical state of the semiconductor memory when the program is encoded therein. For example, firmware 615 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A data storage system, comprising:
a plurality of data storage devices each configured for storage of data at associated storage media densities;
an enclosure configured to encase and physically support the plurality of data storage devices;
a control processor configured to vary storage media densities of ones of the plurality of data storage devices based at least on positioning of the plurality of data storage devices within the enclosure.

2. The data storage system of claim 1, comprising:
the control processor configured to identify vibration characteristics associated the plurality of data storage devices within the enclosure and vary the storage media densities of the ones of the plurality of data storage devices to compensate for the vibration characteristics, wherein the vibration characteristics are at least in part affected by the positioning of the plurality of data storage devices within the enclosure.

3. The data storage system of claim 1, wherein a first data storage device comprises rotating magnetic storage media, and comprising:
the control processor configured to process positioning of the first data storage device within the enclosure and vibration characteristics experienced by the first data storage device to vary a track spacing of storage media of the first data storage device.

4. The data storage system of claim 1, further comprising:
one or more fans configured to provide airflow within the enclosure;
the control processor configured to decrease storage media densities for ones of the plurality of data storage devices proximate to the one or more fans.

5. The data storage system of claim 1, comprising:
the control processor configured to identify when vibration characteristics for at least a first data storage device exceed a vibration threshold and responsively decrease a storage media density for at least the first data storage device.

6. The data storage system of claim 1, comprising:
the control processor configured to identify when a trigger event occurs which alters vibration characteristics within the enclosure, and responsively alter the storage media densities of one or more of the plurality of data storage devices based at least on the altered vibration characteristics.

7. The data storage system of claim 6, wherein the trigger event comprises at least one of a fan malfunction event within the enclosure, an opening event of the enclosure, and a failure event of at least one of the data storage devices.

8. The data storage system of claim 1, comprising:
responsive to varying the storage media densities, the control processor configured to report a change in a storage capacity of the data storage system in accordance with the storage media densities.

9. A method of operating a data storage system, the method comprising:
storing data at associated storage media densities on data storage devices;
varying storage media densities of ones of the plurality of data storage devices based at least on positioning of the plurality of data storage devices within an enclosure that structurally supports the plurality of data storage devices.

10. The method of claim 9, further comprising:
identifying vibration characteristics associated the plurality of data storage devices within the enclosure and varying the storage media densities of the ones of the plurality of data storage devices to compensate for the vibration characteristics, wherein the vibration characteristics are at least in part affected by the positioning of the plurality of data storage devices within the enclosure.

11. The method of claim 9, wherein a first data storage device comprises rotating magnetic storage media, and further comprising:
processing positioning information of the first data storage device within the enclosure and vibration characteristics experienced by the first data storage device to vary a track spacing of storage media of the first data storage device.

12. The method of claim 9, further comprising:
decreasing storage media densities for ones of the plurality of data storage devices proximate to one or more fans configured to provide airflow within the enclosure.

13. The method of claim 9, further comprising:
identifying when vibration characteristics for at least a first data storage device exceed a vibration threshold and responsively decreasing a storage media density for at least the first data storage device.

14. The method of claim 9, further comprising:
identifying when a trigger event occurs which alters vibration characteristics within the enclosure, and responsively altering the storage media densities of one or more of the plurality of data storage devices based at least on the altered vibration characteristics.

15. The method of claim 14, wherein the trigger event comprises at least one of a fan malfunction event within the enclosure, an opening event of the enclosure, and a failure event of at least one of the data storage devices.

16. The method of claim 9, further comprising:
responsive to varying the storage media densities, reporting a change in a storage capacity of the data storage system in accordance with the storage media densities.

17. A data storage device, comprising:
rotating storage media configured to store data;
a vibration sensor configured to monitor vibration characteristics experienced by the data storage device;
a control processor configured to establish a track spacing for storing the data on the rotating storage media based at least on the vibration characteristics.

18. The data storage device of claim 17, comprising:
the control processor configured to monitor the vibration characteristics to determine when the vibration characteristics exceed a vibration threshold, and responsively decrease the track spacing for storing the data on the rotating storage media.

19. The data storage device of claim 17, comprising:
the control processor configured to monitor the vibration characteristics to determine when the vibration characteristics fall below a vibration threshold, and responsively increase the track spacing for storing the data on the rotating storage media.

20. The data storage device of claim 17, comprising:
responsive to establishing the track spacing, the control processor configured to report a change in a storage capacity of the data storage device to a host system in accordance with the track spacing.
